(19) United States
(12) Patent Application Publication
(10) Pub. No.: US 2018/0191765 A1
(43) Pub. Date: Jul. 5, 2018

(54) METHOD AND APPARATUS FOR CALCULATING RISK OF CYBER ATTACK

(71) Applicant: KOREA INTERNET & SECURITY AGENCY, Seoul (KR)

(72) Inventors: HYEI SUN CHO, Seoul (KR); Seul Gi Lee, Seoul (KR); Nak Hyun Kim, Seoul (KR); Byung Ik Kim, Seoul (KR); Tae Jin Lee, Seoul (KR)

(21) Appl. No.: 15/421,015

(22) Filed: Jan. 31, 2017

(30) Foreign Application Priority Data
Jan. 3, 2017 (KR) 10-2017-0000504

(51) Int. Cl. H04L 29/06

(52) U.S. Cl. CPC H04L 63/1433; H04L 63/1425

(57) ABSTRACT

Provided are a method and apparatus for calculating a risk of cyber attacks, and, more particularly to a method and apparatus for calculating a risk of cyber attacks, by which the risk of cyber attacks is quantitatively calculated by analyzing cyber incident information associated with the cyber attacks. The method of calculating a risk, which is performed by a risk calculation apparatus, the method comprises acquiring cyber incident information associated with a risk calculation target attack, the cyber incident information including a plurality of pieces of individual cyber incident information and the plurality of pieces of individual cyber incident information being hierarchically configured, calculating an individual risk index of individual cyber incident information using a predetermined risk calculation criterion and a standard risk index according to the predetermined risk calculation criterion, calculating a level risk index by summing the individual risk indexes for each level of the cyber incident information and calculating a total risk index for the risk calculation target attack using a weight for each predetermined level and the level risk index.

This application claims priority from Korean Patent Application No. 10-2017-0000504 in the Korean Intellectual Property Office, the disclosure of which is incorporated herein by reference in its entirety.

### BACKGROUND

### 1. Field of the Invention

The present invention relates to a method and apparatus for calculating a risk of cyber attacks, and, more particularly to a method and apparatus for calculating a risk of cyber attacks, by which the risk of cyber attacks is quantitatively calculated by analyzing cyber incident information associated with the cyber attacks.

### 2. Description of the Related Art

With the development of information and communication technology, cyber attacks are increasingly occurring in various forms, and thus the scale and extent of damages are also increasing day by day. Therefore, it is emphasized that there is a need to establish preventive measures against the occurrence of cyber incidents caused by cyber attacks.

Recent cyber incidents tend to reuse IP, domain or malicious code possessed by attackers after a predetermined period of time. When objectively analyzing the information related to the recent cyber incidents using the characteristics of the cyber incidents, systematic prediction of future cyber attacks is possible, and thus rapid analysis and response is possible.

However, there has been a lack of objective and quantitative evaluation of future cyber attacks by analyzing cyber incident information related to cyber attacks detected so far.

### SUMMARY

An aspect of the present invention is to provide a method and apparatus for calculating a risk of cyber attacks, by which the risk of each cyber attack is quantitatively evaluated based on the cyber incident information associated with cyber attacks.

Another aspect of the present invention is to provide a method and apparatus for calculating a risk of cyber attacks, by which the risk of each cyber attack is calculated based on the hierarchical cyber incident information obtained by recursively collecting cyber incident information associated with cyber attacks.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a method of calculating a risk, which is performed by a risk calculation apparatus, the method comprises acquiring cyber incident information associated with a risk calculation target attack, the cyber incident information including a plurality of pieces of individual cyber incident information and the plurality of pieces of individual cyber incident information being hierarchically configured, calculating an individual risk index of individual cyber incident information using a predetermined risk calculation criterion and a standard risk index according to the predetermined risk calculation criterion, calculating a level risk index by summing the individual risk indexes for each level of the cyber incident information and calculating a total risk index for the risk calculation target attack using a weight for each predetermined level and the level risk index.

According to another aspect of the present invention, there is provided an apparatus for calculating a risk, comprises, at least one processor, a network interface, a memory unit loading computer program executed by the processor and a storage unit storing the computer program, wherein the computer program includes an operation of acquiring cyber incident information associated with a risk calculation target attack, the cyber incident information including a plurality of pieces of individual cyber incident information, and the plurality of pieces of individual cyber incident information being hierarchically configured, an operation of calculating an individual risk index of the individual cyber incident information using a predetermined risk calculation criterion and a standard risk index for each predetermined risk calculation criterion, an operation of calculating a level risk index by summing the individual risk indexes for each level of the cyber incident information and an operation of calculating a total risk index for the risk calculation target attack using the weight for each predetermined level and the level risk index.

According to another aspect of the present invention, there is provided a computer program, which is stored in a recording medium to be executed in connection with a computing device, the computer program comprising the steps of acquiring cyber incident information associated with a risk calculation target attack, the cyber incident information including a plurality of pieces of individual cyber incident information, and the plurality of pieces of individual cyber incident information being hierarchically configured, calculating an individual risk index of the individual cyber incident information using a predetermined risk calculation criterion and a standard risk index for each predetermined risk calculation criterion, calculating a level risk index by summing the individual risk indexes for each level of the cyber incident information and calculating a total risk index for the risk calculation target attack using the weight for each predetermined level and the level risk index.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of a risk calculation system for cyber attacks according to an embodiment of the present invention;

FIG. 2 is a flowchart of a recursive collection method of cyber incident information that may be referred to in some embodiments of the present invention;

FIGS. 3 and 4 are block diagrams for explaining an example of a recursive collection method of cyber incident information;

FIG. 5 is a functional block diagram of a risk calculation apparatus for cyber attacks according to another embodiment of the present invention;

FIG. 6 is a hardware block diagram of a risk calculation apparatus for cyber attacks according to still another embodiment of the present invention;

FIGS. 7 to 9B are views for explaining a risk calculation method for cyber attacks according to still another embodiment of the present invention;

FIGS. 10A and 10B are diagrams for explaining a method of calculating a risk in consideration of the reliability of an cyber incident information sharing channel, which may be referred to in some embodiments of the present invention; and

FIG. 11 is a view for explaining a specific example of the risk calculation method.

### DETAILED DESCRIPTION OF THE EMBODIMENTS

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

The terms used herein are defined as follows.

First, the cyber attacks refer to all actions that can cause social or economic damages by attacking networks or computer systems using information and communication technologies such as hacking and computer viruses.

The cyber threat indicator refers to information about IP, domain, malicious codes, e-mail, etc exploited in cyber attacks. For example, the cyber threat indicator may include domain information, IP information, hash information of malicious codes, E-mail information, and the like.

The associated indicator refers to information associated with the cyber threat indicator. For example, when the cyber threat indicator is a domain, the associated indicator may top level domain (TLD)/second level domain (SLD)-based similar domain information. The associated indicator may vary depending on the type of the cyber threat indicator, and detailed examples of the associated indicator will be described later.

The cyber incident information sharing channel is an information channel that provides cyber threat indicator or associated indicator. The provided information may vary for each channel, and detailed examples of the cyber incident information sharing channel will be described later.

The cyber incident information is a concept that includes all types of information associated with cyber attacks. That is, it can be understood that the cyber incident information is a term of a wider concept that includes cyber threat indicator and associated indicator utilized in cyber attacks and that includes not only information collected through the cyber incident information sharing channel but also information created or processed based on the collected information. In the related technical field, the term ‘cyber incident information’ can be used with a term ‘cyber observable’ interchangeably.

The risk of cyber attacks refers to a value obtained by expressing the degree of whether the same or similar cyber attack can be performed again by an objective and quantitative numerical value.

Hereinafter, the present invention will be described in more detail with reference to the attached drawings.

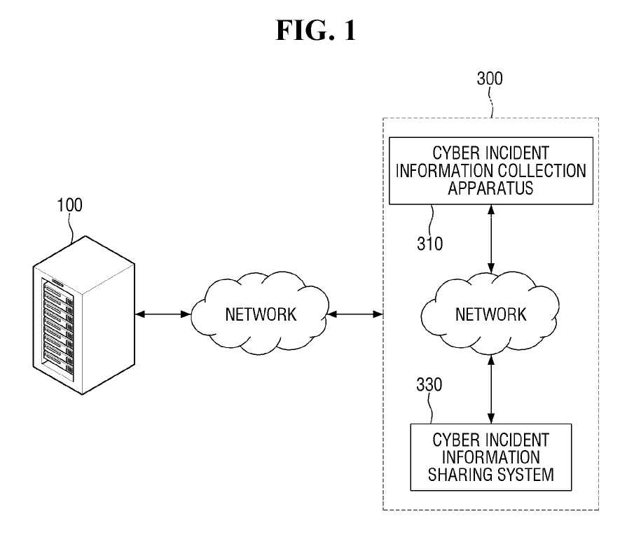

FIG. 1 is a block diagram of a risk calculation system according to an embodiment of the present invention.

The risk calculation system is a system that collects various types of cyber incident information associated with cyber attacks corresponding to risk calculation targets and analyzes the collected cyber incident information to calculate the risk of cyber attacks. Here, the cyber incident information associated with cyber attacks includes all types of cyber incident information directly or indirectly associated with cyber attacks. For example, the cyber incident information directly associated with cyber attacks may refer to cyber threat indicator directly used in cyber attacks, and the cyber incident information indirectly associated with cyber attacks may refer to associated indicator associated with the cyber threat indicator.

The risk calculation system may include a risk calculation apparatus 100 for calculating the risk of cyber attacks, and an cyber incident information collection system 300 for collecting cyber incident information associated with cyber attacks. The cyber incident information collection system 300 may include a cyber incident information collection apparatus 310 and a cyber incident information sharing system 330. However, this configuration is only a preferred embodiment for achieving the object of the present invention, and it goes without saying that some components may be added or deleted as needed.

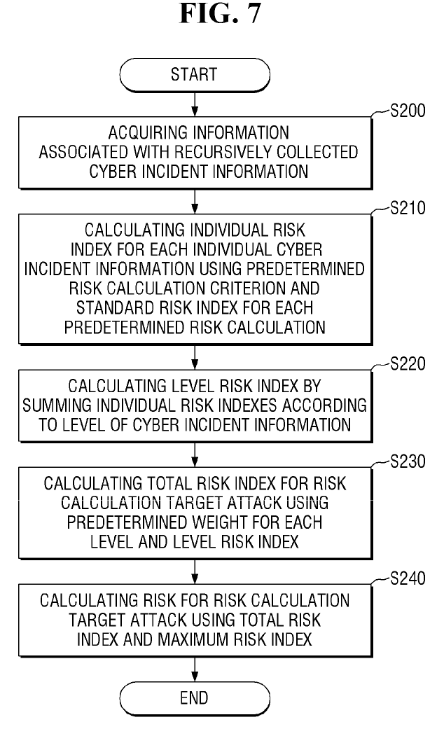

The risk calculation apparatus 100 is a computing apparatus that acquires cyber incident information associated with risk calculation target attacks from the cyber incident information collection system 300 and calculates the risk for the risk calculation target attacks based on the acquired cyber incident information. Here, the computing apparatus may be, but is not limited to, a notebook, a desktop, a laptop, or a smart phone. The computing apparatus may include all kinds of apparatuses provided with computing and communication functions. Details of the method of calculating the risk for the risk calculation target attacks using the risk calculation apparatus 100 will be described in detail later with reference to FIGS. 7 to 11.

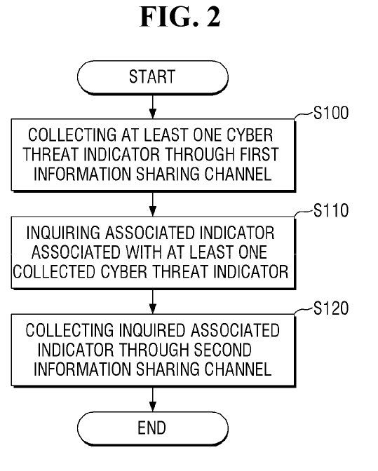

The cyber incident information collection apparatus 310 recursively collects cyber incident information from an internal storage device or the external cyber incident information sharing system 330 using the association between predetermined cyber incident information. For example, the cyber incident information collection apparatus 310 may collect cyber threat indicator exploited in cyber attacks, may recursively collect first associated indicator associated with the collected cyber threat indicator through an information sharing channel of the cyber incident information sharing system 330, and may recursively collect second associated indicator associated with the first associated indicator. The method of recursively collecting the cyber incident information will be described later with reference to FIGS. 2 to 4.

For reference, although it is shown in FIG. 1 that the risk calculation apparatus 100 and the cyber incident information collection apparatus 310 are physically independent apparatuses, the risk calculation apparatus 100 and the cyber incident information collection apparatus 310 may also be implemented in the same apparatus in different logic forms according to embodiments. That is, in this case, the risk calculation apparatus 100 may recursively collect cyber incident information directly, and may calculate the risk for risk calculation target attacks based on the collected cyber incident information.

The cyber incident information sharing system 330 is a system for managing cyber incident information such that the cyber incident information can be shared among various apparatuses. The cyber incident information sharing system 330 provides information associated with cyber incidents through various information sharing channels. For example, the information sharing channel may be a cyber black box, a C-share (cyber incident information sharing system operated by Korea Internet & Security Agency), a domain name server based black list (DNSBL), a distribution site/malicious code sharing site such as virusshare.com, or the like.

The cyber incident information collection apparatus 310 and the cyber incident information sharing system 330 may be connected through a network, and the risk calculation apparatus 100 and the infringe accident collection system 300 may be connected through a network. Here, the network may be implemented as all kinds of wired/wireless networks, such as local area network (LAN), wide area network (WAN), mobile radio communication network, and wireless broadband internet (WIBRO).

Up to now, the risk calculation system according to an embodiment of the present invention has been described with reference to FIG. 1. Hereinafter, first, a recursive collection method of cyber incident information will be described with reference to FIG. 2 to FIG. 4, and then a risk calculating apparatus and risk calculating method for calculating a risk based on the recursively collected cyber incident information with reference to FIG. 2 to FIG. 4.

Hereinafter, it is assumed that each step of the recursive collection method of cyber incident information according to the embodiment of the present invention is performed by the risk calculation apparatus 100 or the cyber incident information collection apparatus 310. However, for convenience of explanation, it should be noted that the subject of each operation included in the recursive collection method of cyber incident information may be omitted. For reference, each step of the recursive collection method of the cyber incident information may be implemented by a computer program, and may be an operation performed by the risk calculation apparatus 100 or the cyber incident information collection apparatus 310.

FIG. 2 is a flow chart of a recursive collection method of cyber incident information. However, this method is only a preferred embodiment for achieving the object of the present invention, and it goes without saying that some steps may be added or deleted as needed.

Referring to FIG. 2, the cyber incident information collection apparatus 310 collects at least one cyber threat indicator used in cyber incidents through a first information sharing channel provided by the cyber incident information sharing system 330 (S110). Here, the first information sharing channel may be a cyber black box, a C-share (cyber incident information sharing system operated by Korea Internet & Security Agency), a domain name server based black list (DNSBL), a distribution site/malicious code sharing site such as virusshare.com, or the like, but the present invention is not limited thereto. Further, the at least one cyber threat indicator may include domain information, IP information, hash information of malicious code, and e-mail information, which are abused in infringement attacks.

In this case, depending on the type of the first information sharing channel, the cyber threat indicator that can be collected by the cyber incident information collection apparatus 310 may vary. For example, when the first information sharing channel is a C-share, the cyber incident information collection apparatus 310 may collect malicious code distribution site/routing site, C&C (Command & Control) IP, and hash information of malicious codes, from the C-share.

As another example, when the first information sharing channel is a blacklist channel of DNSBL, the cyber incident information collection apparatus 310 may collect blacklist IP information, real-time black list (RBL) information, and blacklist domain information, which are exploited in cyber incidents, from the blacklist channel.

As another example, when the first information sharing channel is a malicious code sharing site, the cyber incident information collection apparatus 310 may collect hash information of new or variant malicious codes from the malicious code sharing site.

According to embodiments, the cyber incident information collection apparatus 310 periodically accesses the malicious code sharing site, inquires new and variant malicious code information, and inquires about hash or original file information of the new and variant malicious code information. That is, when the cyber incident information collection apparatus 310 periodically accesses the malicious code sharing site and updates new information, the cyber incident information collection apparatus 310 may inquire new and variant malicious code information by crawling a web page. For example, the cyber incident information collection apparatus 310 periodically accesses the main page of virusshare.com to check a hash value, and collects new and variant malicious code information and original file information from virusshare.com when the hash value of recently collected malicious codes is inconsistent with the confirmed hash value.

Next, the cyber incident information collection apparatus 310 inquires associated indicator associated with the at least one cyber threat indicator collected in the previous step (S100) (S110). Here, the relationship between the cyber threat indicator and the associated indicator and the relationship between pieces of the associated indicator may be predetermined.

Next, the cyber incident information collection apparatus 310 collects the inquired associated indicator through a second information sharing channel (S120). That is, the cyber incident information collection apparatus 310 collects the associated indicator recursively associated with the cyber threat indicator collected through the first information sharing channel again. In addition, the cyber incident information collection apparatus 310 may repeatedly recursively collect associated indicator associated with the associated indicator collected through the second information sharing channel.

Here, the second information sharing channel may include, but is not limited to, a DNS/PTR record, Whois, IP2Location, a Google cyber incident history, SLD (Second Level Domain), TLD (Top Level Domain), a malicious code similarity analysis system, a file analysis system, and SPEED, and may also include the aforementioned first information sharing channel.

For example, when the second information sharing channel is a DNS/PTR record, the cyber incident information collection apparatus 310 may collect DNS record information for domain activation and PTR record information for IP activation from the DNS/PTR record.

As another example, when the second information sharing channel is Whois, the cyber incident information collection apparatus 310 may collect the owner information of the corresponding domain from the Whois.

As another example, when the second information sharing channel is IP2Location, the cyber incident information collection apparatus 310 may collect the country code (CC), geographical information (latitude/longitude) and internet service provider (ISP) of the corresponding IP from the IP2Location.

As another example, when the second information sharing channel is at least one of a Google cyber incident history, SLD, a file analysis system, a malicious code similarity analysis system, SPEED, and TLD, the cyber incident information collection apparatus 310 may collect a malicious code distribution history, a vaccine diagnosis name, an SLD reference similar domain, API call information, static/dynamic analysis result information, malicious code similarity information, vaccine check information, TLD reference similar domain information, and the like from the aforementioned second information sharing channel.

Up to now, the recursive collection method of cyber incident information according to the present invention has been described with reference to FIG. 2. According to the above-described method, it is possible to collect various and sufficient types of cyber incident information by collecting cyber threat indicator included in the cyber incident information and recursively collecting associated indicator associated with the cyber threat indicator. Accordingly, it is possible to analyze the cyber incident information from various views, and it is possible to establish effective countermeasures against cyber attacks causing cyber incidents.

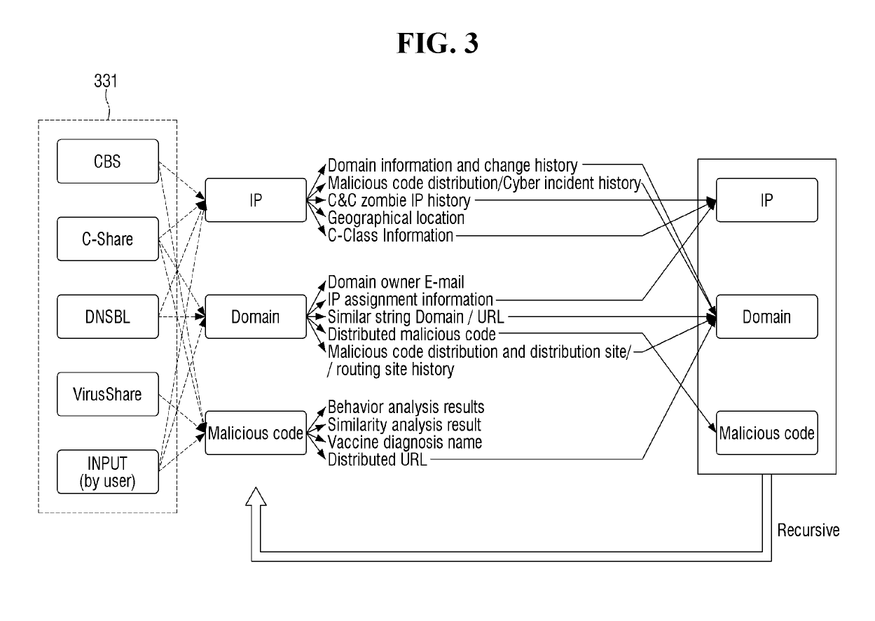

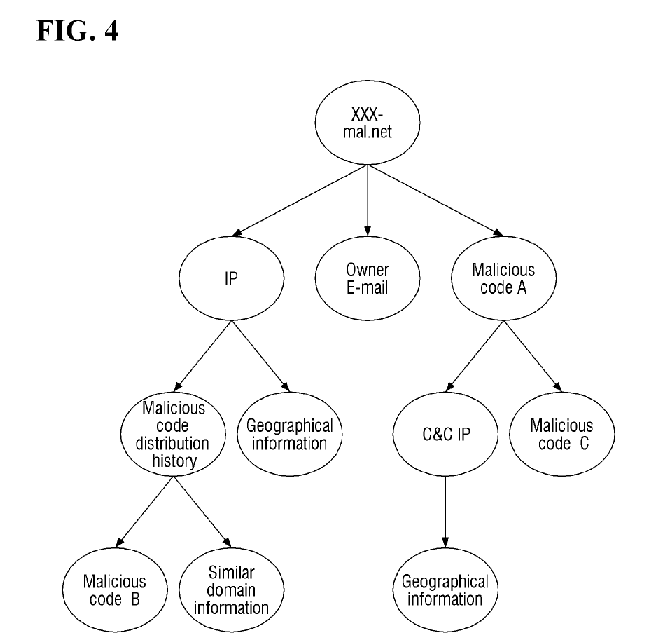

Next, in order to provide the convenience of understanding, an example of the recursive collection method of cyber incident information according to the present invention will be described with reference to FIGS. 3 and 4.

FIG. 3 is a block diagram showing a process of collecting recursively associated cyber incident information.

As shown in FIG. 3, the cyber incident information collection apparatus 310 collects cyber threat indicator (IP, domain, and malicious code) from various information sharing channels 331, and further collect associated indicator, such as domain change information, a domain change history, a history of malicious code distribution/cyber incident abuse, and a geographical location, which are associated with each of the cyber threat indicator (IP, domain, and malicious code).

In addition, the cyber incident information collecting apparatus 310 collects recursively associated associated indicator again, when the type of the aforementioned associated indicator corresponds to IP, domain, or malicious code, which is cyber threat indicator. However, even though the type of the first associated indicator does not correspond to an cyber threat indicator, the cyber incident information collection apparatus 310 may recursively collect second associated indicator when the second associated indicator, different from the first associated indicator, exists.

Next, FIG. 4 is a diagram showing the cyber incident information collected according to the recursive collection method of cyber incident information in a graphical form.

Referring to FIG. 4, the recursively collected cyber incident information includes cyber threat indicator and associated indicator, the cyber threat indicator directly used in cyber attacks is located at a high level hierarchy according to recursive collection, and associated indicator associated with the cyber threat indicator is located at a lower level hierarchy connected to the higher level hierarchy. For example, cyber incident information may be organized in a tree structure, and each node in the tree structure may indicate collected individual cyber incident information.

Specifically, the cyber incident information collection apparatus 310 collects a domain (XXX-mal.net) utilized in cyber attacks, and recursively collects associated indicator (IP, owner E-mail, and malicious code A) associated with the domain (XXX-mal.net). Here, it can be understood that the associated indicator (IP) indicates an IP of the domain (XXX-mal.net), the associated indicator (owner e-mail) indicates an e-mail of the domain (XXX-mal.net) owner, and the associated indicator (malicious code A) indicates a malicious code distributed in the domain (XXX-mal.net).

The cyber incident information collection apparatus 310 may recursively collect associated indicator (malicious code distribution history, geographical information, C&C IP, and malicious code C) associated with the associated indicator (IP, owner E-mail, and malicious code A) again. This associated indicator may be schematized as a hierarchical graph as shown in FIG. 4, when it is graphically shown according to the recursive collection level. Hereinafter, for convenience of explanation, the information corresponding to each node of the graph is referred to as individual cyber incident information. For example, it can be understood that the individual cyber incident information located at the uppermost hierarchy in FIG. 4 is domain information corresponding to “XXX-mal.net”, and pieces of the individual cyber incident information associated with this individual cyber incident information (XXX-mal.net) are “IP of domain XXX-mal.net”, “owner E-mail of domain XXX-mal.net”, and “malicious code A distributed in domain XXX-mal.net”, respectively.

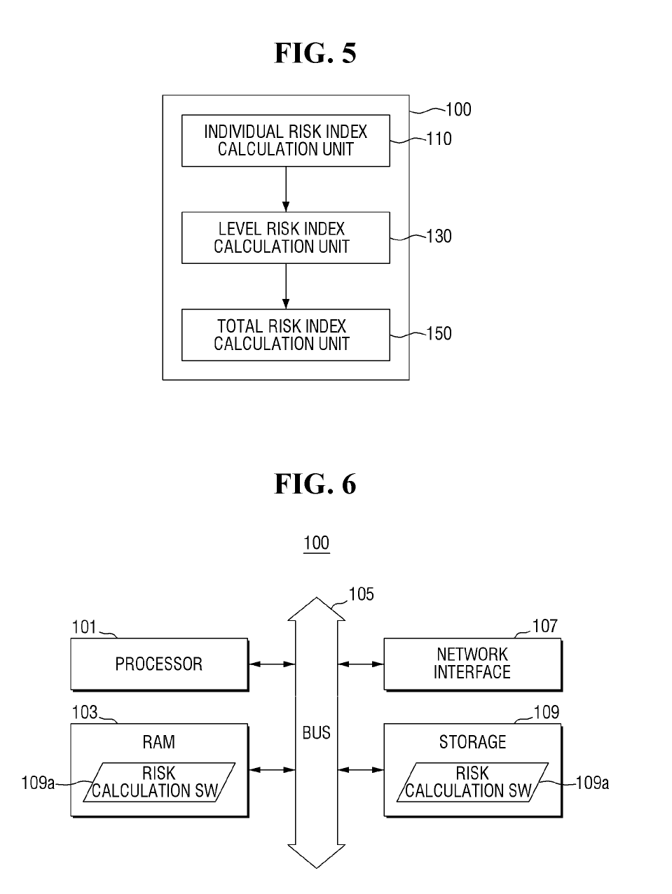

Up to now, the recursive collection method of cyber incident information according to the present invention has been described with reference to FIGS. 2 to 4. Next, the configuration and operation of a risk calculation apparatus for calculating a risk for a risk calculation target attack based on the recursively collected cyber incident information will be described with reference to FIGS. 5 and 6.

First, FIG. 5 is a functional block diagram of a risk calculation apparatus 100 according to another embodiment of the present invention.

Referring to FIG. 5, the risk calculation apparatus 100 may include an individual risk index calculation unit 110, a level risk index calculation unit 130, and a total risk index calculation unit 150. However, only the components related to the embodiment of the present invention are shown in FIG. 5. Accordingly, it will be appreciated by those skilled in the art that other general-purpose components may be further included in addition to those shown in FIG. 5.

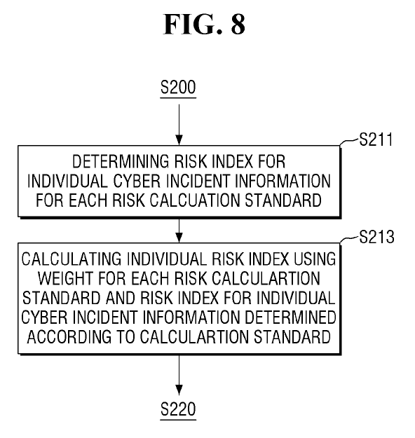

Regarding each component, the individual risk index calculation unit 110 calculates an individual risk index (IRI) for individual cyber incident information. The individual risk index (IRI) is calculated using predetermined risk calculation criteria and a standard risk index for each risk calculation criterion. Specifically, the individual risk index calculation unit 110 may calculate the individual risk index (IRI) by comparing a risk index of individual cyber incident information with the standard risk index to determine the risk index of the individual cyber incident information for each risk calculation criterion and obtaining the sum of the weight for each predetermined risk calculation criterion and the weight of the risk index of the individual cyber incident information determined for each risk calculation criterion. Details of the method of calculating the risk index for individual cyber incident information using the the individual risk index calculation unit 110 will be described later with reference to FIG. 8.

Next, the level risk index calculation unit 130 calculates a level risk index (LRI) by summing the individual risk indexes calculated by the individual risk index calculation unit 110 for each level of cyber incident information. For reference, it should be noted that, in this specification, the term “level” or “hierarchy” may be interchangeably used, but they indicate the same meaning.

Finally, the total risk index calculation unit 150 calculates a total risk index (TRI) using the level risk index calculated by the level risk index calculation unit 130 and the weight for each level. For example, the total risk index calculation unit 150 may calculate the total risk index by calculating the sum of the level risk index calculated by the level risk index calculation unit 130 and the weight for each level. Details of the method of calculating the total risk index for risk calculation target attacks will be described later with reference to FIGS. 7 to 11.

For reference, the total risk index calculation unit 150 may further calculate a maximum risk index (MRI) in addition to the total risk index, and may calculate final risk by calculating the ratio of the total risk index and the maximum risk index. Details of the method of calculating the risk will be described later with reference to FIGS. 7 to 11.

Each of the components in FIG. 5 may refer to software or hardware such as field programmable gate array (FPGA) or application-specific integrated circuit (ASIC). However, the above components are not limited to software or hardware. That is, these components may be configured to be provided in an addressable storage medium, and may also be configured to execute one or more processors. The functions provided in the components may be implemented by more segmented components, and may also implemented by one component that performs a specific function by combining a plurality of components.

Next, FIG. 6 is a hardware block diagram of a risk calculation apparatus 100 according to still another embodiment of the present invention.

Referring to FIG. 6, the risk calculation apparatus 100 may include at least one processor 101, a bus 105, a network interface 107, a memory unit 103 loading computer program executed by the processor 101, and a storage unit 109 storing risk calculation software 109a. However, only the components related to the embodiment of the present invention are shown in FIG. 6. Accordingly, it will be appreciated by those skilled in the art that other general-purpose components may be further included in addition to those shown in FIG. 6.

The processor 101 controls the overall operation of each configuration of the risk calculation apparatus 100. The processor 101 may be configured to include a central processing unit (CPU), a microprocessor unit (MPU), a microcontroller unit (MCU), a graphic processing unit (GPU), or any type of processor well known in the art. The processor 101 may perform an operation on at least one application or program for performing the methods according to the embodiments of the present invention. The risk calculation apparatus 100 may include one or more processors.

The memory unit 103 stores various data, commands and/or information. The memory unit 103 may load one or more programs 109a from the storage unit 109 in order to perform the risk calculation method according to embodiments of the present invention. In FIG. 6, RAM is shown as an example of the memory unit 103.

The bus 105 provides a communication function between the components of the risk calculation apparatus 100. The bus 105 may be implemented as various types of buses such as an address bus, a data bus, and a control bus.

The network interface 107 supports the wired/wireless internet communication of the risk calculation apparatus 100. The network interface 107 may also support various communication methods in addition to the internet communication. For this purpose, the network interface 107 may be configured to include a communication module well known in the technical field of the present invention.

The network interface 107 may transmit and receive cyber incident information from the cyber incident information collection system 300 shown in FIG. 1 through a network.

The storage unit 109 may non-temporarily store the one or more programs 109a. In FIG. 6, the risk calculation software 109a is shown as an example of the one or more programs 109a.

The storage unit 109 may be configured to include non-volatile memory such as ROM (Read Only Memory), EPROM (Erasable Programmable ROM), EEPROM (Electrically Erasable Programmable ROM) or flash memory, a hard disk, a detachable disk, or any type of computer-readable recording medium well known in the technical field of the present invention.

The risk calculation software 109a may calculate the risk for risk calculation target attacks by analyzing the cyber incident information on the risk calculation target attacks according to the embodiment of the present invention.

Specifically, the risk calculation software 109a is loaded in the memory unit 103, and acquires cyber incident information associated with risk calculation target attacks by the one or more processors 101. Here, the cyber incident information includes a plurality of pieces of individual cyber incident information, and the plurality of pieces of individual cyber incident information is hierarchically configured. The risk calculation software 109a may perform an operation of calculating an individual risk index of the individual cyber incident information using predetermined risk calculation criteria and a standard risk index for each predetermined risk calculation criterion, an operation of calculating a level risk index by summing the individual risk indexes for each level of the cyber incident information, and an operation of calculating a total risk index for the risk calculation target attacks using the weight for each predetermined level and the level risk index.

Up to now, the configuration and operation of the risk calculation apparatus 100 according to the embodiment of the present invention have been described with reference to FIGS. 5 and 6. Next, a method for calculating the risk for the risk calculation target attacks by analyzing the recursively collected cyber incident information will be described in detail with reference to FIGS. 7 to 11.

Hereinafter, it is assumed that each step of the risk calculation method according to the embodiment of the present invention is performed by the risk calculation apparatus 100 or the cyber incident information collection apparatus 310. However, for convenience of explanation, it should be noted that the subject of each operation included in the risk calculation method n may be omitted. For reference, each step of the risk calculation method may be may be an operation performed by the risk calculation apparatus 100 by allowing the risk calculation software 109a to be executed by the processor 101.

FIG. 7 is a flowchart of the risk calculation method. However, this configuration is only a preferred embodiment for achieving the object of the present invention, and it goes without saying that some steps may be added or deleted as needed.

Referring to FIG. 7, the risk calculation apparatus 100 acquires cyber incident information associated with risk calculation target attacks (S200). As described above, the risk calculation apparatus 100 may receive cyber incident information from the cyber incident information collection system 300. Further, the risk calculation apparatus 100 itself may collect cyber incident information from the cyber incident information sharing system 330 when it is provided with a recursive collection function of cyber incident information.

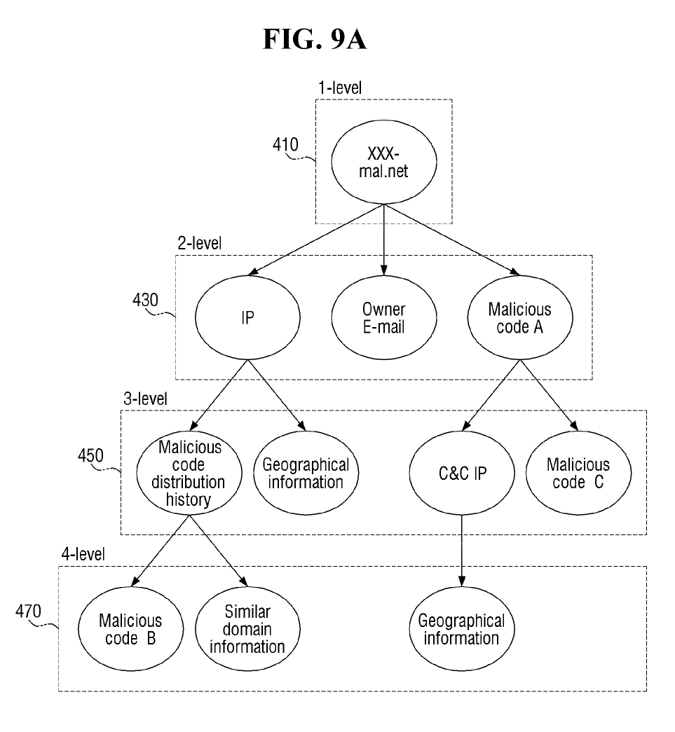

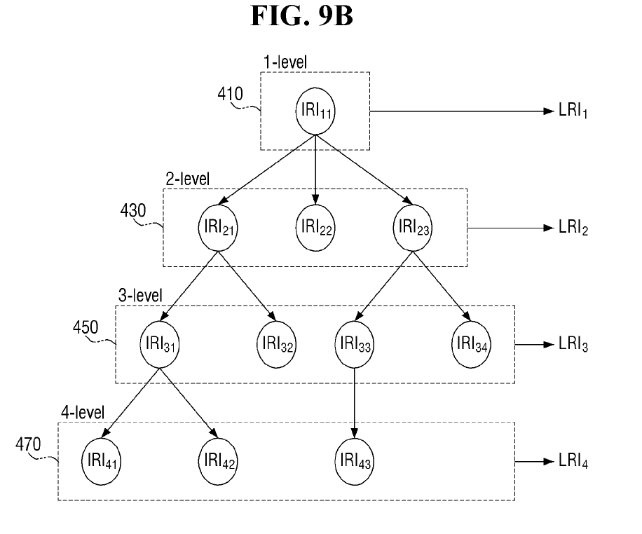

Here, the cyber incident information, as shown in FIG. 9A, may refer to information composed of a plurality of levels 410, 430, 450, and 470 according to the recursive collection level, and the individual cyber incident information may be information about IP information, domain information, and malicious code information.

Next, the risk calculation apparatus 100 calculates an individual risk index for each individual cyber incident information using predetermined risk calculation criteria and a standard risk index for each predetermined risk calculation criterion (S210).

Here, the risk calculation criteria and the standard risk index for each risk calculation criterion may be set as given in Table 1 below. However, it should be noted that the risk calculation criteria and standard risk indexes given in Table 1 are merely examples, and may vary depending on application environment. In Table 1, it means that the higher the standard risk index, the higher the risk.

TABLE 1

| Hierarchy | Risk calculation criteria | | Standard |
|---|---|---|---|
| (weight) | (weight) | Index | risk index |
| 1-level (6) | □Detection path (6) | Malicious code | 5 |
| | | distribution site | |
| | | C&C IP | 5 |
| | | Malicious code | 3 |
| | | routing site | |
| | □Detection time (2) | Within 1 month | 5 |
| | | 1~3 months | 3 |
| | | 3 month ago | 1 |
| | □Whether blacklist | Live | 3 |
| | registration (2) | un-Live | 1 |
| 2-level (3) | □DNS change history (2) | ~10 | 5 |
| 3-level (1) | | 11~40 | 3 |
| | | 41~ | 1 |
| | □ The number of | ~10 | 5 |
| | malicious URLs (3) | 11~40 | 3 |
| | | 41~ | 1 |
| | □ The number of | ~10 | 5 |
| | malicious codes (5) | 11~40 | 3 |
| | | 41~ | 1 |

Referring to Table 1, risk calculation criteria may include a detection path, a detection time, whether blacklist registration, a DNS change history, the number of malicious URLs, and the number of malicious codes. Further, according to embodiments, different risk calculation criteria may be set for each level (recursive collection level) of cyber incident information. For example, the risk calculation criteria set in the 1-level hierarchy may include a detection path, a detection time, and whether blacklist registration, and the risk calculation criteria set in the level 2 or higher hierarchies may include a DNS change history, the number of malicious URLs, and the number of malicious codes. However, in order to calculate a risk in a more accurate manner, the risk calculation criteria set for each level may vary.

In Table 1, when the collected cyber incident information is information associated with a detection path, the risk index of C&C IP or malicious code distribution site may be set higher than that of malicious code routing site. This reflects the fact that attack information directly utilized in cyber attacks is relatively high in risk.

Also, the more recent the collected cyber incident information is detected, the higher the standard risk index may be set. This reflects the fact that the cyber threat indicator utilized in cyber attacks tends to be reused after a predetermined period of time. That is, it can be understood that the recently detected information has a relatively high risk.

In addition, when the collected cyber incident information is registered as a blacklist, the standard risk index may be set higher. This reflects the fact that the blacklisted cyber threat indicator has a relatively high risk.

Also, the more the DNS change history, the malicious URLs and the malicious codes are included in the collected cyber incident information, the higher the reference risk index may be set. This reflects the fact that the more the DNS change history, the malicious URLs and the malicious codes, the higher the risk. For reference, the DNS change history may include an IP change history for a given domain and a domain change history for a given IP.

The risk calculation apparatus 100 calculates an individual risk index using the risk calculation criteria and standard risk index exemplified in Table 1 (S210). When additionally explaining this step (S210) with reference to FIG. 8, the risk calculation apparatus 100 determines a risk index for individual cyber incident information according to the risk calculation criteria (S211). For example, when the individual cyber incident information is domain information (XXX-mal.net) located at the first level hierarchy, the risk calculation apparatus 100 determines the risk index of the individual cyber incident information (XXX-mal.net) for each of the detection routing site, the detection time and whether blacklist registration. More specifically, when the individual cyber incident information (XXX-mal.net) is a malicious code distribution site, is detected within one month and is a domain registered in the blacklist, the risk indexes of the individual cyber incident information (XXX-mal.net) may be 5, 5, and 3, respectively.

Next, the risk calculation apparatus 100 calculates an individual risk index using the risk index of the individual cyber incident information determined for each weight of the risk calculation criteria and for each risk calculation criteria (S213).

The individual risk index (IRI) may be calculated, for example, using the sum of weights, as shown in Equation 1 below. In Equation 1 below, i is a number indentifying the risk calculation criterion, and wᵢ is a weight assigned to the risk calculation criterion (i).

$$IRI = {\sum }_{i = 1}^{i = n} ( {w}_{i} \times {RI}_{i} ) \qquad [ Equation 1 ]$$

For reference, the weight value for each risk calculation criterion is a value that reflects the extent of the influence of cyber incident information meeting each risk calculation criterion on a risk. The weight values for each risk calculation criterion may be different from each other, and may vary depending on application environment.

Referring to FIG. 7 again, the risk calculation apparatus 100 calculates a level risk index by summing the individual risk indexes for each level of cyber incident information (S220).

For example, as shown in FIG. 9B, the risk calculation apparatus 100 may calculate a level risk index (LRI₁) of 1-level 410 using the individual risk index (RI₁₁) determined in the previous step (S220), and may calculate a level risk index (LRI₂) of 2-level 430 by summing the individual risk indexes (R₂₁, RI₂₂, and RI₂₃).

The level risk index (LRI) may be represented by Equation 2 below. In Equation 2 below, i is a number of individual cyber incident information located at the same level, and IRIᵢ is an individual risk index of the individual cyber incident information (i) determined in the previous step (S220).

$$LRI = {\sum }_{i = 1}^{i = n} {IRI}_{i} \qquad [ Equation 2 ]$$

Referring to FIG. 7 again, after calculating the level risk index for each hierarchy, the risk calculation apparatus 100 calculates a total risk index for risk calculation target attacks using the predetermined weight for each level and the level risk index calculated in the previous step (S220) (S230).

The total risk index may be calculated by the sum of the predetermined weight (wₗₑᵥₑₗ) for each level and the weight of the level risk index (LRI), as represented by Equation 3. In Equation 3 below, i is a level number, wⁱₗₑᵥₑₗ is a weight for each level of level (i), and LRIᵢ is a level risk index of level (i) determined in the previous step (S220). For reference, in Equation 3 below, the total risk index may be calculated as a weighted average for convenience of calculation, and, in this case, the total of weights (wⁱₗₑᵥₑₗ) for each level may be set to 1.

$$TRI = {\sum }_{i - 1}^{i = n} ( {w}_{level}^{i} \times {LRI}_{i} ) \qquad [ Equation 3 ]$$

It is preferred that the weight (wⁱₗₑᵥₑₗ) for each level is set to a smaller value toward the lower level. The reason for this is that cyber threat indicator directly utilized in risk calculation target attacks is located at a high level, and associated indicator slightly associated with risk calculation targets is located at a low level. That is, it is preferred that the weight for each level at a higher level is set to a smaller value by reflecting the fact that, according to the recursive collection, the association with the cyber incident decreases with the increase of a collection level.

Next, the risk calculation apparatus 100 calculates a maximum risk index for the risk calculation target attacks, and calculates a ratio of the total risk index to the maximum risk index, so as to calculate a risk for the risk calculation target attacks (S240). The reason why the risk calculation apparatus 100 calculates the risk is that the total risk index is an absolute risk index calculated by analyzing cyber incident information, and pieces of individual cyber incident information collected for each cyber attack may be different from each other. That is, since it is difficult to fairly compare the risks of the first cyber attack and the second cyber attack using the total risk index calculated based on pieces of individual cyber incident information different from each other, it can be understood that the numerical value is converted into the risk corresponding to a relative risk index.

The maximum risk index may be calculated, for example, by Equation 4 below. In Equation 4 below, i is a level number, and max(LRIᵢ) is the maxim level risk index of the level risk indexes of level (i). Here, the maxim level risk index may be calculated by the sum of the weight of the maximum individual risk index and the predetermined weight for each item. Further, the maximum individual risk index means a maximum value of the standard risk index.

$$MRI = {\sum }_{i = 1}^{i = n} ( {w}_{level}^{i} \times max ( {LRI}_{i} ) ) \qquad [ Equation 4 ]$$

Further, the risk for each risk calculation target attack may be calculated by Equation 5 below. That is, the risk for each risk calculation target attack may be represented by a percentage of the ratio of the total risk index (TRI) to the maximum risk index (MRI).

RISK=(TRI/MRI)×100 [Equation 5]

Meanwhile, in order to calculate the risk for the risk calculation target attack, the risk calculation apparatus 100 may calculate the risk by reflecting the reliability of the cyber incident information sharing channel in addition to the aforementioned weight for each risk calculation criterion and weight for each level. Here, it can be understood that the reliability of the cyber incident information sharing channel is a value indicating how much the information provided through the cyber incident information sharing channel can be trusted.

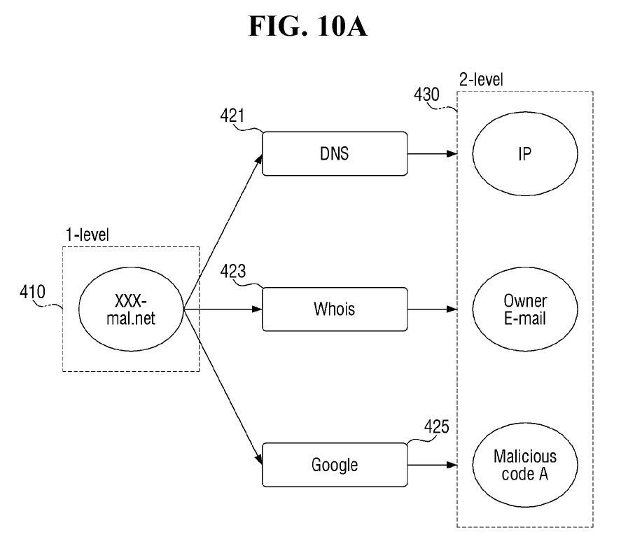

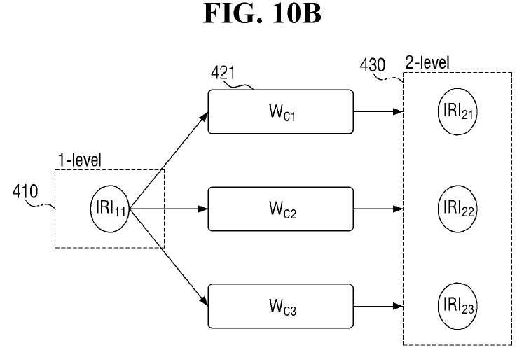

The reliability of the cyber incident information sharing channel will be further described with reference to FIGS. 10A to 10B.

Referring to FIGS. 10A and 10B, pieces of the cyber incident information of the second level 430 are collected from the cyber incident information sharing channels such as the DNS 421, Whois 423 and Google infringement history 425, respectively. In this case, as shown in FIG. 10B, predetermined weights W_{c1}, W_{c2}, and W_{c3} may be given to the cyber incident information sharing channels, respectively.

Depending on the implementation manner, the weights W_{c1}, W_{c2}, and W_{c3} for the cyber incident information sharing channels may be used to adjust the risk indexes RI₂₁, RI₂₂, and RI₂₃ of the individual cyber incident information collected through the corresponding infringing information sharing channels. For example, the individual risk indexes RI₂₁, RI₂₂, and RI₂₃ may be adjusted by multiplying or adding individual risk indexes RI₂₁, RI₂₂, and RI₂₃ to the weights W_{c1}, W_{c2}, and W_{c3}.

Up to now, the method of calculating the risk for the risk calculation target attack based on cyber incident information has been described in detail with reference to FIGS. 7 to 10. According to the aforementioned method, it is possible to provide an opportunity to first cope with a high-risk cyber attack by quantitatively calculating the risk of each cyber attack. That is, since the high-risk cyber attack is a cyber attack that is likely to be attacked again in the future, it is possible to provide an opportunity to take a countermeasure first by analyzing the high-risk cyber attack.

Specifically, the risk calculation method and apparatus according to the embodiment of the present invention may be utilized in connection with various cyber incident information detection systems for detecting cyber incident information related to cyber attacks. For example, the risk calculation method and apparatus may be utilized in connection with a cyber incident information detection system, such as an intrusion detection system (IDS), installed in various companies or organizations. In fact, since the cyber incident information detection system installed in the companies or organizations detects several thousands of pieces of cyber incident information per day, there is a limitation in analyzing all types of detected cyber incident information. Thus, there is a limitation in that it is not possible to appropriately analyze a dangerous cyber incident in real time or in a timely manner. Therefore, the collected cyber incident information is prioritized using the risk calculated based on the risk calculation criteria (detection path, detection time, blacklist, etc.) and the standard risk index, and cyber incidents are sequentially or selectively analyzed according to the priority, thereby effectively coping with intimidating cyber incidents. In particular, considering that, currently, most of security association systems constructed in the related technical field are not systems for blocking or defending cyber attacks, but systems for detecting cyber incident information related to cyber attacks, the risk calculation method and apparatus according to the present invention can be said to be highly utilized.

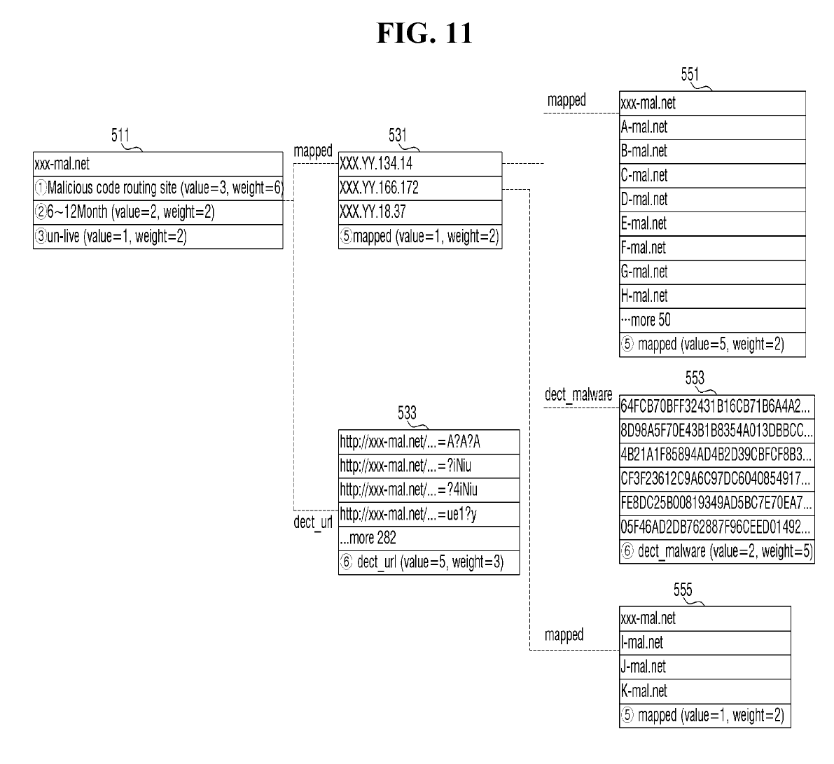

Next, for better understanding, an example of calculating the risk for the risk calculation target attack based on the collected cyber incident information will be described with reference to FIG. 11. In FIG. 11, it is assumed that the risk calculation criteria, standard risk indexes and various weights used for calculating the risk are given in Table 1. Further, it is assumed that the circle numbers \textcircled{1},\textcircled{2}, \textcircled{3}, \textcircled{5}, and \textcircled{6} shown in pieces of the individual cyber incident information 511, 531, 533, 551, 553, and 555 indicate the corresponding risk calculation criteria in Table 1, and risk indexes are respectively calculated by the above-described Equations. In addition, for convenience of calculation, it is assumed that the total risk index is calculated as a weighted average of level risk indexes.

Referring to FIG. 11, the cyber incident information associated with the risk calculation target attack includes individual cyber incident information 510 at 1-level, individual cyber incident information 531 and 533 at 2-level, and individual cyber incident information 551, 553, and 555 at 3-level.

Briefly explaining individual cyber incident information, the individual cyber incident information 511 indicates domain (xxx-mal.net) information used in the risk calculation target attack, and the individual cyber incident information 531 indicates IP change history information of the domain (xxx-mal.net). Further, the individual cyber incident information 533 indicates malicious URL information detected from the domain (xxx-mal.net), and the individual cyber incident information 551, 553 and 555 are domain change history information corresponding to IP information (XXX.YY.134.14) of the individual cyber incident information 531, malicious code information detected from the IP information (XXX.YY.134.14), and domain history information corresponding to IP information (XXX.YY.166.172).

Next, explaining the process of calculating each individual risk index, it can be ascertained that the individual cyber incident information 511 indicates domain (xxx-mal.net) information, the domain (XXX-mal.net) indicates ‘a malicious code routing site’, the detection time is ‘nine months ago’, and the domain (XXX-mal.net) is not registered in the blacklist. Therefore, the individual risk index of individual cyber incident information becomes 24 (6*3+2*2+1*2=24, left operands 6/2/1 mean weights according to risk calculation criteria, and right operands 3/2/2 mean risk indexes according to risk calculation criteria).

When calculating the individual cyber incident information 531 and 533 in the same manner, the individual risk indexes of the individual cyber incident information 531 and 533 become 2 (2*1=2) and 15 (3*5=15), respectively, and the individual risk indexes of the individual cyber incident information 551, 553 and 555 become 10 (2*5=10), 10 (5*2=10), and 2 (2*1=2), respectively.

Next, when obtaining level risk indexes, the level risk index at the first level becomes 24, the level risk index at the second level becomes 17 (2+15=17), and the level risk index at the third level becomes 22 (10+10+2=22).

Next, when calculating a total risk index, the total risk index of a risk calculation target attack becomes 10.4 (0.6*24+0.3*17+0.1*22=10.4, left operands 0.6/0.3/0.1 mean weights according to levels, and right operands 24/17/22 mean level risk indexes).

Next, when obtaining maximum risk indexes in order to calculate a risk, the maximum risk index of the individual cyber incident information 511 becomes 50 (6*5+2*5+2*5=50, left operands 6/2/2 mean weights according to risk calculation criteria, and right operands 5/5/5 mean the maximum values of the standard risk indexes). When calculating the maximum risk indexes of the individual cyber incident information 531 and 533 in the same manner, the maximum risk indexes of the individual cyber incident information 531 and 533 become 10 (2*5=10) and 15 (3*5=15), respectively, and the maximum risk indexes of the individual cyber incident information 551, 553 and 555 become 10 (2*5=10), 25 (5*5=25), and 10 (2*5=10), respectively. Here, when obtain maximum level risk indexes, the maximum level risk index at the first level becomes 50 (30+10+10=50), the maximum level risk index at the second level becomes 25 (10+15=25), and the maximum level risk index at the third level becomes 45 (10+25+10=45). Further, the maximum risk index becomes 42 (0.6*50+0.3*25+0.1*45=42, left operands 0.6/0.3/0.1 mean weights according to levels, and right operands 24/17/22 mean the maximum risk indexes according to hierarchies).

Finally, since the risk is a ratio of the total risk index to the maximum risk index, it may become about 24.76% (10.4/42*100≈24.76).

Up to now, a detailed example of calculating a risk has been described with reference to FIG. 11. As described above, it can be ascertained that the risk for a risk calculation target attack may be calculated as a quantified value by rationally quantifying the standard risk index for each risk calculation criterion and providing a predetermined weight.

The concepts of the present invention having been described above with reference to FIGS. 1 to 11 may be implemented as computer-readable codes on a computer-readable recording medium. Examples of the computer-readable recording medium may include portable recording media (CD, DVD, Blu-ray Disc, USB storage device, and portable hard disk) and fixed recording media (ROM, RAM, and computer-equipped hard disk). The computer program recorded in the computer-readable recording medium may be transmitted to another computing device through a network such as an internet to be installed in another computing device, and thus this computer program may be used in another computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

As described above, according to the present invention, it is possible to provide an opportunity to first cope with a high-risk cyber attack by calculating the risk of each cyber attack.

The effects of the present invention are not limited by the foregoing, and other various effects are anticipated herein.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of calculating a risk, which is performed by a risk calculation apparatus, the method comprising:
acquiring cyber incident information associated with a risk calculation target attack, the cyber incident information comprising a plurality of pieces of individual cyber incident information and the plurality of pieces of individual cyber incident information being hierarchically configured;
calculating an individual risk index of the individual cyber incident information using a predetermined risk calculation criterion and a standard risk index for each predetermined risk calculation criterion;
calculating a level risk index by summing the individual risk index for each level of the cyber incident information; and
calculating a total risk index for the risk calculation target attack using a predetermined weight for each level and the level risk index.

2. The method of claim 1,
wherein the cyber incident information comprises IP information, domain information, and malicious code information.

3. The method of claim 1,
wherein the calculating the individual risk index comprises:
determining a risk index of the individual cyber incident information according to the risk calculation criterion; and
calculating the individual risk index using a weight for each risk calculation criterion and the risk index of the individual cyber incident information determined according to the risk calculation criterion.

4. The method of claim 1,
wherein the risk calculation criteria are set to different risk calculation criteria for each level of the cyber incident information.

5. The method of claim 4,
wherein the hierarchy of the cyber incident information comprises a first level and a second level lower than the first level,
the risk calculation criterion set at the first level comprises a detection path, a detection time, and whether blacklist registration, and
the risk calculation criterion set at the second level comprises a DNS change history, the number of malicious URLs, and the number of malicious codes.

6. The method of claim 1,
wherein the risk calculation criterion comprises a detection path, a detection time, and whether blacklist registration, a DNS change history, the number of malicious URLs, and the number of malicious codes.

7. The method of claim 1,
wherein the predetermined risk calculation criterion comprises a detection path, and
the standard risk index for the detection path is set to a standard risk index, which is higher when the detection path is a C&C communication site or a malicious code distribution site compared to when the detection path is a malicious code routing site.

8. The method of claim 1,
wherein the predetermined risk calculation criterion comprises a detection time, and
the standard risk index for the detection time is set to a standard risk index, which is higher as the detection time is recent.

9. The method of claim 1,
wherein the predetermined risk calculation criterion comprises whether blacklist registration, and
the standard risk index for whether blacklist registration is set to a standard risk index, which is higher when the blacklist registration exists.

10. The method of claim 1,
wherein the predetermined risk calculation criterion comprises a DNS change history, the number of malicious URLs, and the number of malicious codes, and
the standard risk index for each of the DNS change history, the number of malicious URLs, and the number of malicious codes is set to a standard risk index, which is higher as each of the DNS change history, the number of malicious URLs, and the number of malicious codes increases.

11. The method of claim 1,
wherein the predetermined weight for each level is set to a smaller value as it goes to a lower level.

12. The method of claim 1, further comprising:
calculating a maximum value of the individual risk index for individual cyber incident information using the predetermined risk calculation criterion and maximum value of the standard risk index according to the predetermined risk calculation criterion;
calculating maximum value of the level risk index by summing the maximum value of the individual risk indexe and calculating a maximum risk index for the risk calculation target attack using the predetermined weight for each level and the maximum value of the level risk index; and
calculating a ratio of the total risk index to the maximum risk index to determine a risk for the risk calculation target attack.

13. An apparatus for calculating a risk, comprising:
at least one processor;
a network interface;
a memory unit loading computer program executed by the processor; and
a storage unit storing the computer program,
wherein the computer program comprises:
an operation of acquiring cyber incident information associated with a risk calculation target attack, the cyber incident information comprising a plurality of pieces of individual cyber incident information, and the plurality of pieces of individual cyber incident information being hierarchically configured;
an operation of calculating an individual risk index of the individual cyber incident information using a predetermined risk calculation criterion and a standard risk index for each predetermined risk calculation criterion;
an operation of calculating a level risk index by summing the individual risk index for each level of the cyber incident information; and
an operation of calculating a total risk index for the risk calculation target attack using a predetermined weight for each level and the level risk index.

14. A computer program, which is stored in a recording medium to be executed in connection with a computing apparatus, the computer program comprising the steps of:
acquiring cyber incident information associated with a risk calculation target attack, the cyber incident information comprising a plurality of pieces of individual cyber incident information, and the plurality of pieces of individual cyber incident information being hierarchically configured;
calculating an individual risk index of the individual cyber incident information using a predetermined risk calculation criterion and a standard risk index for each predetermined risk calculation criterion;
calculating a level risk index by summing the individual risk index for each level of the cyber incident information; and
calculating a total risk index for the risk calculation target attack using a predetermined weight for each level and the level risk index.
